(19) United States
(12) Patent Application Publication
(10) Pub. No.: US 2015/0275151 A1
(43) Pub. Date: Oct. 1, 2015

(54) DISSOLVABLE AQUEOUS GELS WITH HIGH CHELANT LOADING

(71) Applicants: ROHM AND HAAS COMPANY, Philadelphia, PA (US); DOW GLOBAL TECHNOLOGIES LLC, Midland, MI (US)

(72) Inventors: Yonnie D. Yun, Shanghai (CN); Wei Chen, Shanghai (CN); Oliver Spangenberg, Antibes (DE)

(21) Appl. No.: 14/438,242

(22) PCT Filed: Oct. 26, 2012
(86) PCT No.: PCT/CN2012/083599

§ 371 Date: Apr. 24, 2015

(51) Int. Cl. C11D 17/00; C11D 3/26; C11D 1/26; C11D 3/33

(52) U.S. Cl. CPC C11D 17/003; C11D 3/33; C11D 3/26; C11D 1/26

(57) ABSTRACT

Described are aqueous gel compositions for forming a chelant gel, comprising from 4 wt. % to 60 wt. % chelating agent selected from at least one of Ethylenediaminetetraacetic acid, Glutamic acid N,N-Diacetic acid, Methylglycinediacetic acid, and Nitrilotriacetic acid, 2 to 8 wt. % of a gel forming component, comprising a) carboxy methylcellulose, or b) a mixture comprising an ionic or acidic polysaccharide, a dispersible clay, and polyvinyl alcohol; and from 0.01 to 10 wt. % of a salt; provided that the chelant gel is at least partially dissolvable in water.

### FIELD

The present invention relates to a home care compositions, and particularly compositions for automatic dishwashers.

### BACKGROUND

Chelating agents, such as EDTA (Ethylenediaminetetraacetic acid), GLDA (Glutamic acid N,N-Diacetic acid), MGDA (Methylglycinediacetic acid), NTA (Nitrilotriacetic acid), are key enablers for phosphate-free detergents. Besides having the ability to chelate metal ions and decrease the hardness of water, chelating agents also exhibit strong bonding with organic and inorganic soils, which enables good cleaning performance. Additionally, some chelating agents, such as GLDA, MGDA, and NTA are considered very biodegradable and environmentally friendly.

Unit dose systems offer unparalleled ease of use to consumers, but thus far, developing unit dose systems with relatively high chelating agent concentration has been elusive.

Accordingly, in the home care field, there is a need for materials which encapsulate or entrain relatively high levels of chelating agents and then release the chelants under dishwashing conditions.

### DETAILED DESCRIPTION

In one embodiment, the present invention provides aqueous gel compositions for forming a chelant-containing gel (“chelant gel”), comprising a chelating agent selected from at least one of Ethylenediaminetetraacetic acid, Glutamic acid N,N-Diacetic acid, Methylglycinediacetic acid, and Nitrilotriacetic acid, a gel forming component, comprising a) carboxy methylcellulose, or b) a mixture comprising an ionic or acidic polysaccharide, a dispersible clay, and polyvinyl alcohol; and from a salt; provided that the chelant gel is at least partially dissolvable in water.

“Aqueous gel composition” refers to the fact that greater than 39% by weight of the aqueous gel composition (“wt. %”) is water, preferably greater than 59 wt. % water, and in some embodiments, greater than 80 wt. % water. In one embodiment, at least 20% is water, preferably at least 40 wt. %, more preferably at least 50 wt. %, more preferably at least 60 wt. %, more preferably at least 70 wt. %, more preferably at least 80 wt. %, up to 90 wt. %.

It is understood that the aqueous gel composition sets, cures, cross-links, or otherwise gels to form the chelant gel. Accordingly, the chelant gel may vary in hardness, but in any case, cannot be a liquid. In one embodiment, however, the chelant gel is finely divided and the resulting particles dispersed in any conventional home care formulation.

In one embodiment, the chelant gel contains 3wt. % to 6wt. % chelant. In one embodiment, the chelant gel contains 6wt. % to 50wt. % chelant.

In some embodiments, the chelant gel loses structure with increasing temperature, i.e., is not heat resistant. In some embodiments, the chelant gel is at least 20% dissolvable in water, preferably 40% dissolvable in water, preferably 60% dissolvable in water, preferably 80% dissolvable in water, and preferably completely dissolvable in water, within 20 minutes, or in some embodiments, within 45 minutes. In one embodiment, the chelant gel dissolves over a period of weeks.

In one embodiment, the gel forming component is carboxy methylcellulose. In one embodiment, the carboxy methylcellulose has a molar degree of substitution MS_{carboxy} of from 0.5 to 1.2, more preferably of from 0.6 to 1.1, and most preferably of from 0.7 to 0.95. Typically, viscosities of 1% by weight aqueous carboxy methylcellulose solutions at 20° C., determined with a Brookfield viscometer, range from 20 to 50000 mPa·s, preferably from 500 to 2000 mPa·s, and more preferably from 2000 to 10000 mPa·s. Examples of commercially available carboxy methylcelluloses that are useful in the present invention include WALOCEL™ CRT 50000 PA (MS_{carboxy}=0.7, 1% by weight Brookfield viscosity=7000 mPa·s), and more preferably CLEAR+STABLE (C&S) 30M (MS_{carboxy}=0.9, 1% by weight Brookfield viscosity=2,700-4,900 mP·s), available from The Dow Chemical Company, Midland, U.S.A.

In some embodiments the composition is free of any cellulose derivative other than carboxy methylcellulose.

In one embodiment, the carboxy methylcellulose is preferably present in the from 0.5 to 5 wt. %, more preferably from 2 to 4 wt. %, and most preferably 3 wt. %.

In one embodiment, the gel forming component is mixture comprising an ionic or acidic polysaccharide, a dispersible clay, and polyvinyl alcohol. Examples of ionic or acidic polysaccharide include gellan, gelatin, pectin, carrageenan, alginic acid, alginates, or mixtures thereof. In one embodiment, the gel forming component has weight ratio of ionic or acidic polysaccharide:dispersible clay:polyvinyl alcohol from 5:1:1, to 1:5:15, preferably 1:1:5. A preferred mixture includes carrageenan, LAPONITE RD clay available from Southern Clay Products, Inc, Austin, Tex., U.S.A., and polyvinyl alcohol.

In one embodiment, the mixture comprising an ionic or acidic polysaccharide, a dispersible clay, and polyvinyl alcohol is preferably present in the from 3 to 10 wt. %, more preferably from 5 to 9 wt. %, and most preferably from 6 to 8 wt. %.

“Salt” refers to at least one inorganic cation. In one embodiment, the salt is monovalent, such as K⁺. In one embodiment, the salt is a divalent cation such as for example Ca²⁺, Mg²⁺, and/or Zn²⁺ cations. The salt is preferably from 0.01 to 5 wt. % of the aqueous gel composition, more preferably from 0.05 to 3 wt. %, more preferably from 0.1 to 2 wt. %, more preferably from 0.1 to 0.5 wt. %.

In one embodiment, the aqueous gel composition further comprises an acrylic polymer thickener, such as ACUSOL 445N acrylic polymer available from The Dow Chemical Company, Midland, U.S.A. In one embodiment, the acrylic polymer thickener is preferably present from 0.01 to 10 wt. % of the aqueous gel composition, more preferably from 1 to 9 wt. %, more preferably from 3 to 8 wt. %, more preferably from 4 to 6 wt. %.

Optional ingredients include those conventionally used in dishwashing, laundry, and toilet cleaning compositions, such as surfactants, builders, extenders, polar solvents and enzymes. Other optional ingredients include colorants and fragrances.

The composition according to the present invention may be prepared by several methods known in the art. The compositions of the present invention have comparable physical properties to traditional gel products, including appearance, texture, and rheology. In some embodiments, the gel is sliceable and moldable, which is very unique in hydrocolloids systems with such moisture content.

### EXAMPLES

### Example 1

An exemplary composition of the present invention is described in Table 1, having the components listed in wt %.

TABLE 1

| | Batch 1 |
|---|---|
| Carrageenan | 1 |
| LAPONITE RD clay | 1 |
| Polyvinyl alcohol | 5 |
| Potassium Chloride | 0.2 |
| EDTA | 5 |
| ACUSOL 445N acrylic polymer | 5 |
| Water | 82.8 |

The Carrageenan, LAPONITE RD clay, and polyvinyl alcohol are dissolved in water with stirring from 300-1500 rpm at 70-90° C. Next, the salt is added, and the stirring is continued for 5 min. The mixture is incubated at 70-90° C., and then the chelating agent slowly added. Applicants have found that the order of addition is crucial. If chelating agent is dissolved before the gel forming components, no gel formation occurs.

Stirring at 300-1500rpm is continued for 15 min to ensure all components dissolve. Next, ACUSOL 445N acrylic polymer or other optional components (such as Surfactants, Builders, Extenders, Polar solvents and Enzymes) are added, maintaining the temperature and stirring for 10 min to ensure adequate mixing (or optional components could be well dispersed with an extruder).

The mixture is then poured into molds, and allowed to cool to form a gel. The final gel is strong and moldable.

The solubility was tested by putting a 15 g sample in 500 mL water (at 25° C. and 60° C. respectively), shaking for 20 min at 150 rpm, then weighing the residue of gel that had not dissolved. Less residue indicates more solubility. In cold water (25° C.), 40% of the gel formed from Batch 1 dissolved. In hot water (60° C.), 100% of the gel formed from Batch 1 dissolved. The dissolvability demonstrated that the gel is soluble in water system, is fit for rapid release applications.

To test stability, the gel formed from Batch 1 was stored in closed container for three months (at room temperature with no direct sunlight). The results showed no water syneresis and no appearance change. Moreover, the gel viscosity did not change compared to its original state.

### Example 2

Exemplary compositions of the present invention are described in Table 2, having the components listed in wt %.

TABLE 2

| | Batch 2 | Batch 3 |
|---|---|---|
| C&S 30M Carboxy methylcellulose | 3 | 3 |
| AlNO₃ | 2 | 2 |
| EDTA | 30 | — |
| MGDA | — | 50 |
| ACUSOL 445N acrylic polymer | 5 | 5 |
| Water | 60 | 40 |

The CMC is dispersed in water at 70-90° C. with stirring from 300-2000 rpm for 5 min, then cooled and stirred for another 10 min. Next, the chelating agent is added at room temperature, with stirring (300-2000rpm) for 20 min to ensure all components dissolve. Next, ACUSOL 445N acrylic polymer or other optional components (such as Surfactants, Builders, Extenders, Polar solvents and Enzymes) are added, maintaining the temperature and stirring for 10 min to ensure adequate mixing (or optional components could be well dispersed with an extruder). Next, the salt (aluminum nitrate) is added, with stirring (300-2000rpm) for 10 min.

The mixture is then poured into molds, and allowed to cool to form a gel. The final gel is strong and moldable.

Batch 2 was not a strong gel (although it could be further processed to have a harder outer shell, such as of carrageenan).

The solubility of Batch 3 was tested by putting a 15 g sample in 500 mL water (at 25° C. and 60° C. respectively), shaking for 20 min at 150 rpm, then weighing the residue of gel that had not dissolved. Less residue indicates more solubility. In cold water (25° C.), 20% of the gel formed from Batch 3 dissolved. In hot water (60° C.), 40% of the gel formed from Batch 3 dissolved. The dissolvability demonstrated that the gel is soluble in water system, is fit for relatively slow release applications.

To test stability, the gel formed from Batch 3 was stored in closed container for three months (at room temperature with no direct sunlight). The results showed no water syneresis and no appearance change. Moreover, the gel viscosity did not change compared to its original state.

### Example 3 (Comparative)

Compositions outside of the present invention are described in Table 3, having the components listed in wt %.

TABLE 3

| | Comparative | Comparative | Comparative | Comparative |
|---|---|---|---|---|
| | Batch A | Batch B | Batch C | Batch D |
| EDTA | 5 | 5 | 5 | 5 |
| Alginate | 1.5 | — | — | — |
| Carrageenan | — | 1.5 | — | — |
| Guar gum | — | — | 1.5 | — |
| LAPONITE | — | — | — | 1.5 |
| RD clay | | | | |
| CaCl₂ | 0.2 | — | — | — |
| KCl | — | 0.2 | — | — |
| Borax | — | — | 0.5 | — |
| ACUSOL | 5 | 5 | 5 | 5 |
| 445N acrylic | | | | |
| polymer | | | | |
| Water | 93.3 | 93.3 | 93.0 | 93.5 |

None of the comparative Batches A, B, C, and D formed a gel. The chelating agent concentration was too high.

1. A dishwashing composition, comprising an aqueous gel with from 4 wt. % to 60 wt. % chelating agent.

2. An aqueous gel composition for forming a chelant gel, comprising:
from 4 wt. % to 60 wt. % chelating agent selected from at least one of Ethylenediaminetetraacetic acid, Glutamic acid N,N-Diacetic acid, Methylglycinediacetic acid, and Nitrilotriacetic acid,
2 to 8 wt. % of a gel forming component, comprising:
a) carboxy methylcellulose, or
b) a mixture comprising an ionic or acidic polysaccharide, a dispersible clay, and polyvinyl alcohol; and
from 0.01 to 10 wt. % of a salt;
provided that the chelant gel is at least partially dissolvable in water.

3. The composition of claim 1, wherein the ionic or acidic polysaccharide is gellan, gelatin, pectin, carrageenan, alginic acid, alginates, or mixtures thereof.

4. The composition of claim 1, the ionic or acidic polysaccharide is carrageenan.

5. The composition of claim 1, further comprising an acrylic polymer thickener.

6. The composition of claim 1, comprising greater than 39 wt. % water.

7. The composition of claim 1, comprising greater than 59 wt. % water.

8. The composition of claim 1, comprising carboxy methylcellulose and greater than 6 wt. % chelant.

9. A laundry composition made from the composition of claim 2.

10. A toilet cleaning composition made from the composition of claim 8.
